(19) United States
(12) Patent Application Publication
(10) Pub. No.: US 2004/0047344 A1
(43) Pub. Date: Mar. 11, 2004

(54) Method and system for an "Always-on" internet device

(76) Inventors: Kevin Hsunko Chan, Fremont, CA (US); Jeng-Feng Lee, Cambridge, MA (US); Lon-Phon Lin, Cupertino, CA (US)

Correspondence Address: PHILIP K. YU, 20955 PATHFINDER ROAD, SUITE 160, DIAMOND BAR, CA, 91765, US

(21) Appl. No.: 10/641,691

(22) Filed: Aug. 14, 2003

Related U.S. Application Data
(60) Provisional application No. 60/403,341, filed on Aug. 15, 2002.
(60) Provisional application No. 60/451,138, filed on Feb. 28, 2003.

(51) Int. Cl. H04L 12/66

(52) U.S. Cl. 370/352; 370/463

(57) ABSTRACT

A method and system for providing an “Always-On” Internet device is disclosed. The Always-On Internet device can be turned on constant due to its use of low power components, while a conventional PC cannot afford to. The Internet device acts as a “hub” for all the network and peripheral connections of the PC. The Internet device can be connected to the Internet and then connected to the conventional PC. The PC's keyboard, video monitor, and mouse connections are re-directed to the Internet device, which then connects to the PC at the PC's keyboard, video and mouse connectors. The Internet device has a switching gear unit that KVM functionality and Internet Connection Sharing, the control of which is transferred between the PC and the Internet device, depending on whether the PC is on or off.

### RELATED APPLICATIONS

The present invention claims priority from provisional applications, serial No. 60/403,341, filed on Aug. 15, 2002, entitled A METHOD AND SYSMTE FOR AN “ALWAYS-ON INTERNET DEVICE,” and serial No. 60/451,138, filed on Feb. 28, 2003, entitled A METHOD AND SYSMTE FOR AN “ALWAYS-ON INTERNET DEVICE.” Both provisional applications are incorporated by reference as if fully set forth herein.

### RELATED FIELD

The present invention relates to a method and system for a device for accessing a global computer information network such as the Internet. More specifically, the present invention relates to a low-power, always-on Internet access device which co-exists with a personal computer.

### ART BACKGROUND

From mid 90's, much of world's resources have been devoted toward building the Internet infrastructure to make Internet access faster, cheaper and more reliable. Finally hundred of millions of sites such as homes and offices are all connected by the Internet. Moreover, in recent years, many of these Internet connections have become 24/7 broadband connections such as DSL and Cable broadband services. As this 24/7 broadband connection becomes more prevailing and popular, it finally provides an always-on and ready-to-use Internet gateway at home and office.

With the advent of always-on broadband Internet era, people have tried to find the best way and the right spot at home and office to open an information window to the Internet world via Internet Appliances with instant, ease-of-use web surfing, email and messenger functionalities to best and fully utilize the Internet. For instance, some setup top boxes enable TV's to be the Internet devices; however, the major drawback has been that the resolution of most conventional TV's and the viewing distance between users and TV's are meant for motion pictures, but not for generic Web pages.

Another example of people's quest for an Internet Appliance is the refrigerators. Some refrigerators provide built-in flat panel (i.e. monitor) on the door to access Internet; however, it combines three major costly parts, namely the refrigerator, flat panel and computer, each with a very different life cycles. People replenish or replace their computers every 3 to 5 years, but such cycle does not hold true for their refrigerators. Besides, most families have only one Internet connection that usually goes to their PC's in most cases if they have one. It would be difficult to have another Internet connection in the kitchen, not to mention that in many countries (regions), kitchens are crowded, hot, humid and full of things that might damage the monitor and computer. In terms of surfing the Internet, users usually want to sit comfortably to enjoy the Internet for either a brief session or a long reading.

Now let's talk about the main work horse for much of the information age, the Personal Computers. Personal Computers have long served as an indispensable way of executing various computing functions such as processing documents, spreadsheets, playing multimedia and games, etc. For the Internet, people use it to surf web sites, send and receive emails and do real-time text and voice communication by some Messenger utilities such as Microsoft Messenger, Yahoo Messenger, AOL Instant Messenger and ICQ. There are also a lot of users who use a PC only to get on the Internet. For such limited purposes, a PC may be too complicated, i.e. overkill, for them.

Referring FIG. 1, it shows the most common PC usage with a 24/7 Internet broadband connection. As shown in FIG. 1, the 24/7 Internet broadband connection such as DSL and Cable modems has been delivered to home and business “always-on” gateways, but not to all the users. Why? Unlike the cellular phones which are always turned on and ready to receive incoming phone calls, in most cases, people tend to turn off their power-hungry, noisy, heated and maintenance-needed computers after finishing their computing tasks to save energy and lifetime of their computers. Turned-off computers are fundamentally at odds with an “always-on” Internet connection and with those prevailing RTC (Real Time Communication) tools like Messenger utilities. As such, the following unfortunate scenarios are quite common:

Users may just want to quickly check their emails, weather conditions and news occasionally, but the time it takes to boot up and turn off computers impedes their motivations and therefore prevents full use of the Internet connection.

Users cannot enjoy diversified multimedia programs such as Internet radio and video over Internet at any time. Users need a simple, instant, always-on, silent and energy-saving device to listen to, and watch those programs instantly whenever they want.

Users cannot get notifications of the incoming emails until turning on the PC and opening email inbox.

Users cannot get signals of incoming voice communication like ordinary phones.

Users cannot get short messages instantly like cellular phones.

Users do not know if someone wants to chat with them (text communication), if the PC is off.

Users cannot get the up-to-date information without polling the web sites.

Internet provides lots of static information and more interestingly, the dynamic and real time information, such as world news, stock information, weather conditions, Messenger utilities, notification of events and VOIP (Voice Over Internet Protocol) application, etc. In order to get the most up-to-date information, or to operate the real time communication tools, the device for using the Internet has to stay on all the time. Despite PCs with state-of-the-art Windows operating system, it is not a perfect as an Internet device for instant, ease-of-use Internet access, let alone for dynamic and real-time application, either. People tend to turn off the PC whenever they could, to save energy. Usually PC's are turned on only when needed, otherwise, PC's are turned off in most cases. With a turned-off PC, users won't be able to get the signal for text, voice communication request (like telephones), fax, and all other real time information. Even for a turned-on PC, it is still a burden for non-PC (non-technical) users to use such a complicated Windows system to just get on the Internet. Additionally, a conventional PC is overburdened with many software applications and tools that tend to become over-kill, when all the user wants is to access the Net. Unlike the low power consumption and always-on faxes, phones and cellular phones that are truly “connected,” people are not really 24/7 connected by the Internet. Indeed, there is a gap between a typical access to the Internet and the “always-on” feature of an Internet broadband connection. “Always-on” broadband Internet gateway has been there (homes and offices), but there has been no suitable “always-on” devices to enable instant, easy to use and real-time Internet access. As will be described in the following, this invention fills this gap by providing an “always-on” information window to the Internet at broadband connected sites, thus truly enabling an “Always-On Internet Device.” More importantly, the present invention achieves such goal by using existing PC peripherals already at the PC user's disposal.

### SUMMARY OF THE PRESENT INVENTION

A method and system for providing an “Always-On” Internet device is disclosed. The Always-On Internet device can be turned on constant due to its use of low power components, while a conventional PC cannot afford to. The Internet device acts as a “hub” for all the network and peripheral connections of the PC. The Internet device can be connected to the Internet and then connected to the conventional PC. The PC's keyboard, video monitor, and mouse connections are re-directed to the Internet device, which then connects to the PC at the PC's keyboard, video and mouse connectors. The Internet device has a switching gear unit that KVM functionality and Internet Connection Sharing, the control of which is transferred between the PC and the Internet device, depending on whether the PC is on or off.

As such, the users can keep the Internet device of the present invention “always-on” without requiring heavy power consumption. Such “always-on” capability allows the users to take advantage of the various applications enabled by the constant access to the Internet. Even when the PC is turned on for computing tasks, control of the Internet access and various peripherals is handed back to the PC in a smooth and seamless way. When the PC is turned off, control is again transferred back to the Internet device.

### BRIEF DESCRIPTION OF THE DRAWINGS

FIG. 1 shows the general personal computer usage scenario for most Internet broadband users.

FIG. 2 shows that the stand-alone box (“AOB”) can serve as an easy-to-use computer.

FIG. 3(A) shows AOB enabling the existing CRT and TFT monitors to be an “Always-On Internet Device” and leveraging existing PC peripherals and sharing Internet Connection. FIG. 3(B) shows AOB enabling Internet connection for multiple PCs using ICS and an Ethernet hub.

FIG. 4(A) shows front and back view of an exemplary AOB external design.

FIGS. 4(B) and 4(C) show side and bottom view of an exemplary AOB design.

FIG. 5 shows a simplified block diagram an exemplary Nimble™ micro computer board inside the AOB.

FIG. 6(A) shows an exemplary Nimble™ Micro computer board, switching gear (design “A”), IO board and front control board.

FIG. 6(B) shows the Nimble™ Micro computer board, switching gear (design “B”), IO board and front control board.

FIG. 6(C) illustrates an Always-On Panel where video signals are from the PC.

FIG. 6(D) illustrates an Always-On Panel where video signals from the built-in computer.

FIGS. 7(A) and (B) illustrate the front and back views of the external design of an exemplary Always-On Box, conveniently termed “V5™.”

FIG. 8(A) illustrates a side view of the interior design of the exemplary V5™.

FIGS. 9(A) and (B) illustrate the logical block diagram of the switching gear. FIG. 9(A) illustrates the booting up of V5™ when the PC already controls the keyboard, video and mouse. FIG. 9(B) illustrates the booting up of the PC when V5™ already controls the keyboard, video and mouse.

FIG. 10(A) illustrates a simplified block diagram for an exemplary mother board for the exemplary V5™.

### DETAILED DESCRIPTION OF THE PREFERED EMBODIMENT

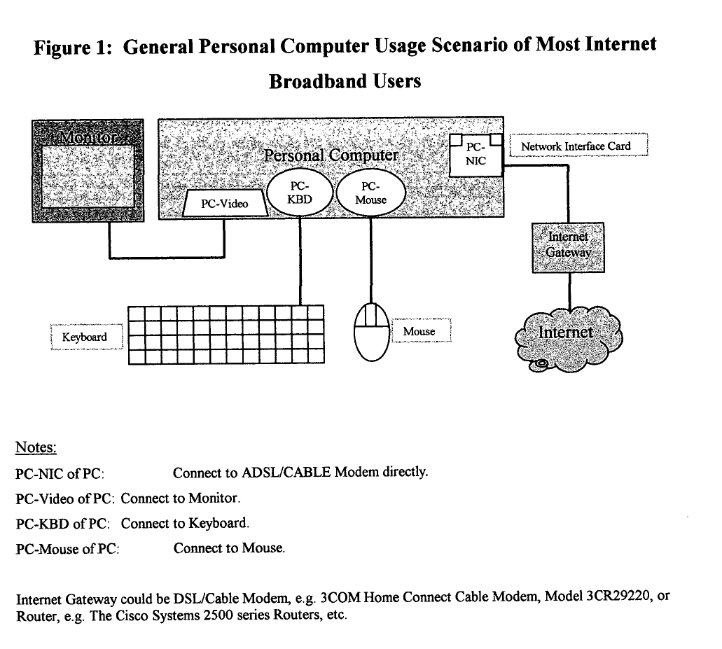

A method and system for an “Always-On Internet Device” is disclosed. Referring again to FIG. 1, it presents the scenario where a PC is equipped with 24/7 Internet broadband connection. However, most people tend to turn off their PC after using it due to those reasons that we mentioned above. As shown in FIG. 1, while the Internet gateway with always-on broadband connection is already in place, a turned-off PC blocks the access, hence the power, of the Internet. Just as our air space is filled with cellular signals, but a turned-off cellular phone will not pick up any incoming phones calls. The present invention is directed to fully utilizing the power of the “always-on” Internet broadband connection, so that people can really have an always-on information window to the Internet.

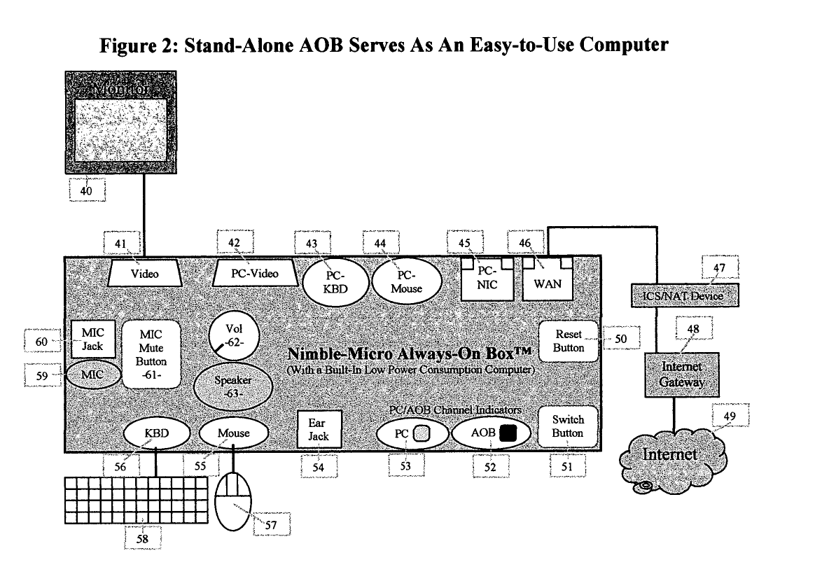

Referring to FIGS. 2, 3, 4(A), 4(B) and 4(C), a system in accordance with the present invention is enclosed in a “box” (“AOB”), or housing, which preferably contains the following operatively-connected functional blocks (as embodied in electrical circuit boards):

a. A RISC-based, Single-board computer: It is a very low power consumption computer and supports both Microsoft Windows CE and Linux operating system. Because of the characteristic of the very low power consumption (compared to a 60W light bulb), 2W, it can stay on constantly.

b. Switching gear and IO board: This board contains a switching gear that is implemented by electrical logic circuit. If users have PC already in place, this switching gear allows the re-use of the existing keyboard, monitor, mouse and Internet connection such that they coexist with the user's existing computer system. This board also holds the connectors of computer peripheral, network and related electrical circuits.

c. A front control board: It is for housing control switches, button, jacks, etc and related electrical circuits.

Referring to FIG. 2, with a built-in RISC-based, single-board computer, such as the one available from Nimble™ Micro (Product Name: Mini-NE-USB), assignee of the present application, AOB can serve as an ease-of-use computer independently. As a single-board computer, this RISC-based Nimble™ Micro computer is designed with compact, no moving parts, quiet, cool operation, low power consumption, low maintenance and ease-of-use characteristics. Therefore it is a good candidate to be an always-on Internet device to get on Internet to surf web sites, handle e-mail, execute the real-time tasks by some Messenger tools as mentioned above, and work as a terminal, etc.

Referring to FIGS. 1 and 2, a conventional PC already comes with its own set of keyboard, mouse and video, which can also be used by the AOB in accordance with the present invention. In most cases, always-on Internet gateway can be located somewhere near the PC and is usually connected to PC directly. Therefore, the easiest way and most convenient place for instant and ease-of-use getting on Internet is still around the PC. As such, AOB advantageously has a mechanism to leverage the existing peripherals (such as keyboard, mouse and video), and Internet connection of a PC.

For PC users, AOB has a built-in switching gear which enables the sharing of the existing keyboard, video and mouse with the PC; that is, AOB's built-in Nimble™ Micro computer and PC are able to share one console, thus achieving what industry calls “KVM,” meaning the sharing, and the necessary switching associated therewith, of keyboard, video and mouse units among different computers or workstations. This built-in switching gear is implemented by electrical logic. As can be appreciated by those skilled in the art, a conventional PC's keyboard, video and mouse units are not normally to be shared with different PCs, i.e. not KVM, since these units are dedicated to such PC. Only with appropriate switching gear can the keyboard, video and mouse units be connected and reconnected among different PCs or workstations, thus achieving KVM.

For keyboard and mouse, a switching integrated circuit with built-in keyboard and mouse simulators is available from Tangtop Technology Company, Ltd., a company in Taiwan, with part number CS-102IC. For switching the video (monitor), a switching IC is available from Pericom Semiconductor Co., a company in the United States, with part number PI5V330.

In addition to sharing one console with the PC, what else can PC users do with their existing Internet broadband connection? In most cases, the Internet broadband connection goes directly to the PC without the use for any Internet connection sharing mechanism. However, AOB's built-in computer also needs Internet connection. Therefore, AOB's built-in switching gear not only switches and re-uses the existing computer peripherals between the PC and computer, but also provides an Internet connection sharing mechanism to let the PC and AOB share one Internet connection.

The following sections will describe how AOB is naturally and seamlessly embedded into a conventional PC environment. The sections will also describe how to operate AOB and furthermore how to design and implement AOB built-in switching gear mechanism.

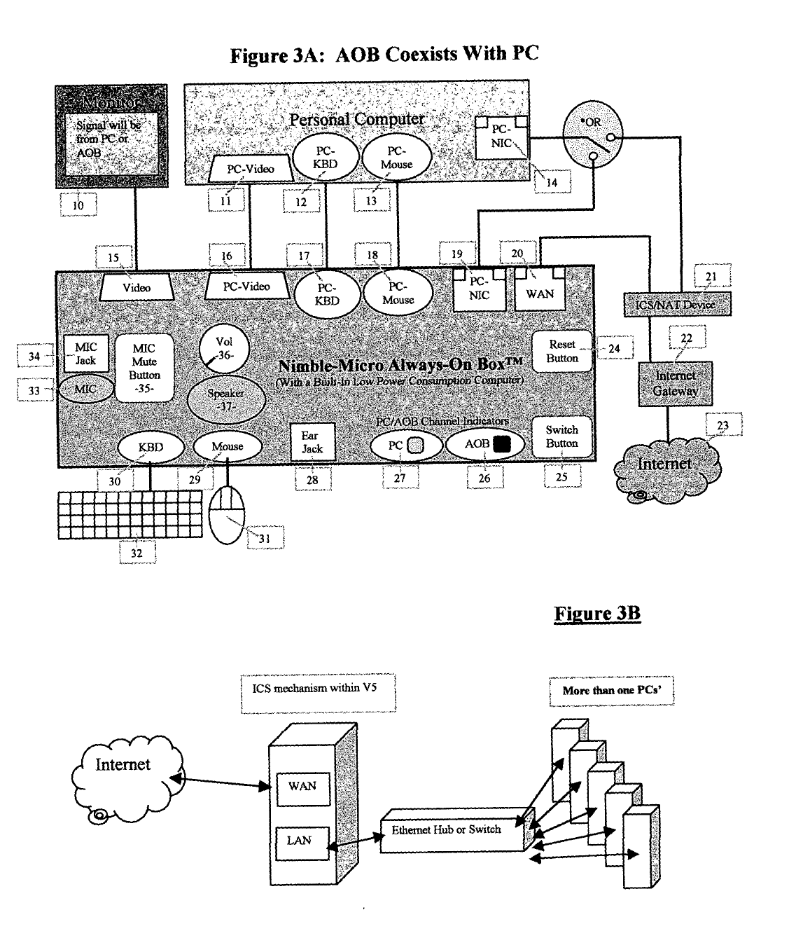

Referring to FIG. 3, having an Always-On Box with a built-in low power consumption computer and a switching gear and rearranging all cable connections can easily enable the 24/7 connections between people and Internet. As shown in FIG. 3, users only need to reconnect the cable connections as described in the following steps:

a. Connect Monitor 10 to Video jack 15 of AOB (“Nimble-Micro Always-On Box”).

b. Connect Keyboard 32 to KBD jack 30 of AOB.

c. Connect Mouse 31 to Mouse jack 29 of AOB.

d. Connect WAN 20 jack to Internet Gateway 22, if system is not equipped with ICS/NAT Device 21.

e. Connect WAN 20 jack to ICS/NAT Device 21, if system is equipped with ICS/NAT Device 21.

f. Connect PC-Video jacks 16 and 11 between AOB and PC.

g. Connect PC-KBD jacks 17 and 12 between AOB and PC.

h. Connect PC-Mouse jacks 18 and 13 between AOB and PC.

i. Connect PC-NIC jacks 14 and 19 between PC and AOB, if system is not equipped with ICS/NAT Device.

j. Connect PC-NIC jacks 14 of PC to ICS/NAT Device 21, if system is equipped with Router with ICS/NAT Device 21.

As can be appreciated by those skilled in the art, “ICS” stands for Internet Connection Sharing and “NAT” stands for Network Address Translation. For example, an EtherFast Cable/DSL Router by Linksys, Model BEFSR41, is a typical ICS/NAT device. Also, Internet Gateway 22 may be a DSL/Cable modem, e.g. 3COM Home Connect Cable Modem, Model 3CR29220, or a router, e.g. CISCO Systems 2500 series routers. Referring to FIG. 3(B), if an Ethernet hub is connected to the LAN connection on AOB, multiple PCs can be connected to the Ethernet hub, thus providing Internet access to more than just one PC. Such ICS functionality and capability is well-known to those skilled in the art.

Referring to FIG. 2 again, without any PC, AOB itself can serve as an ease-of-use computer for users to get on the Internet, etc. In this case, users just disregard the above step, f, g, h, i and j.

For system without ICS/NAT device 47, PC-NIC 45 has no connection (ignored). And WAN 46 is connected to Internet Gateway 48 directly.

For system with ICS/NAT device 47, PC-NIC 45 has no connection (ignored). And WAN 46 is connected to ICS/NAT Device 47 directly. More specifically, the connections are as follows:

| | |
|---|---|
| a. Video 41: | Video output to Monitor 40. |
| b. PC-Video 42: | No connection (ignore). |
| c. PC-KBD 43: | No connection (ignore). |
| d. PC-Mouse 44: | No connection (ignore). |
| e. KBD 56: | Connect to Keyboard 58. |
| f. Mouse 55: | Connect to Mouse 57. |
| g. PC/AOB Switch Button 51: | No use (ignore). |
| h. Reset Button 50: | Reset AOB. |
| i. Vol. Knob 62: | Control speaker 63 volume. |
| j. MIC. Mute Button 61: | Mute microphones 59 & 60. |

If AOB detects that there is no connections of 42, 43, 44 and 45, AOB will disable Switch button 51; that is, AOB will never switch to the PC.

Referring to FIG. 3, after rearranging and reconnecting cables from the conventional arrangement of FIG. 1, users are able to employ AOB built-in switching gear to select video signal from PC, or AOB built-in computer, by toggling Switch Button 25 and AOB built-in computer shares the existing computer peripherals (Keyboard 32, Mouse 31, Monitor 10) and Internet connection devices (ICS/NAT Device 21 and Internet Gateway 22) with PC.

By toggling Switch Button 25, shown in FIG. 3, when PC channel indicator 27 is on, the user can operate the PC just as before. When AOB channel indicator 26 is on, the user will experience an easy-to-use computer which provides a Windows-style Graphic User Interface and many PC-similar functions and tools, such as Browsers to surf web sites, Messengers to make the text/voice/video communications, and Terminal Clients to act as a terminal. By integrating a built-in low-power consumption RISC-based, single-board computer and switching gear together, the AOB in accordance with the present invention creates a new way by leveraging existing computer peripherals and Internet connection to enable the existing video monitors to be an “Always-On Internet Device”.

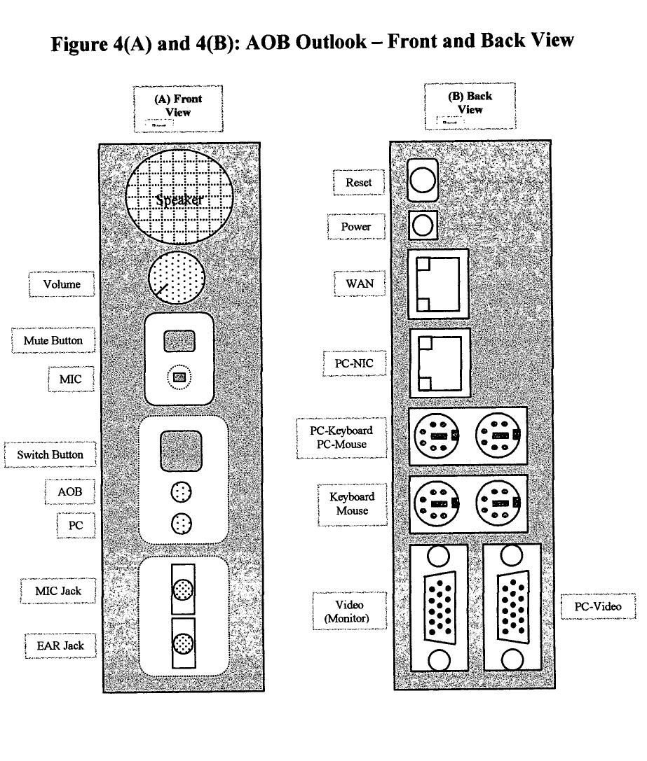

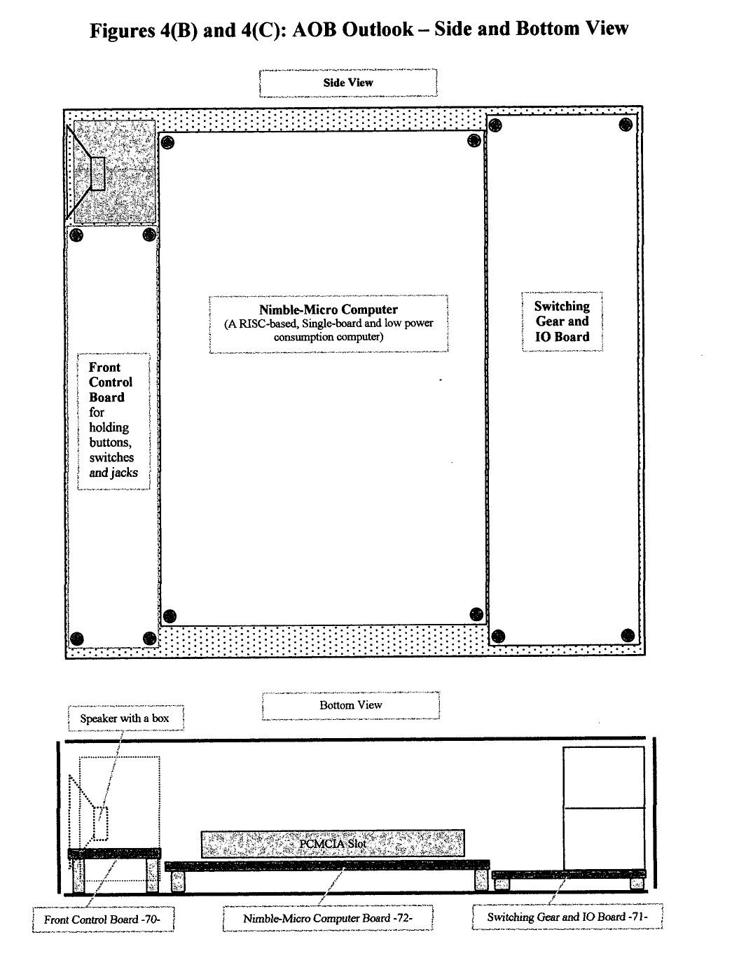

Referring to FIGS. 4(A) and (B), one exemplary ID design of AOB is shown, including the front/back view, side view and bottom view. As shown on the side and bottom view in FIG. 4(B), AOB has three major electrical circuit boards: front control board 70, switching gear and IO board 71 and micro computer board 72, which are connected, e.g. by cables or busses.

Front control board 70 is for holding the ear/MIC jacks, mute/switch buttons, channel indicator LCD's, variable resistor for volume and related circuit (also shown on front view). Switching gear and IO board 71 is for the IO connectors such as monitor, keyboard, mouse, networks and power jack, and reset button and related circuit (also shown on back view). Switching gear and IO board 71 also preferably contains the electrical logic circuit of AOB switching gear. Computer board 72, e.g. Nimble Micro Computer, is a completely integrated SBC (single-board computer) which includes RISC-CPU, SDRAM and Flash memory, Graphic controller (for video), Audio controller (for voice), Network controller (for network connectivity) and PCMCIA, etc. The following sections will describe in more detail the above three exemplary electrical circuit boards.

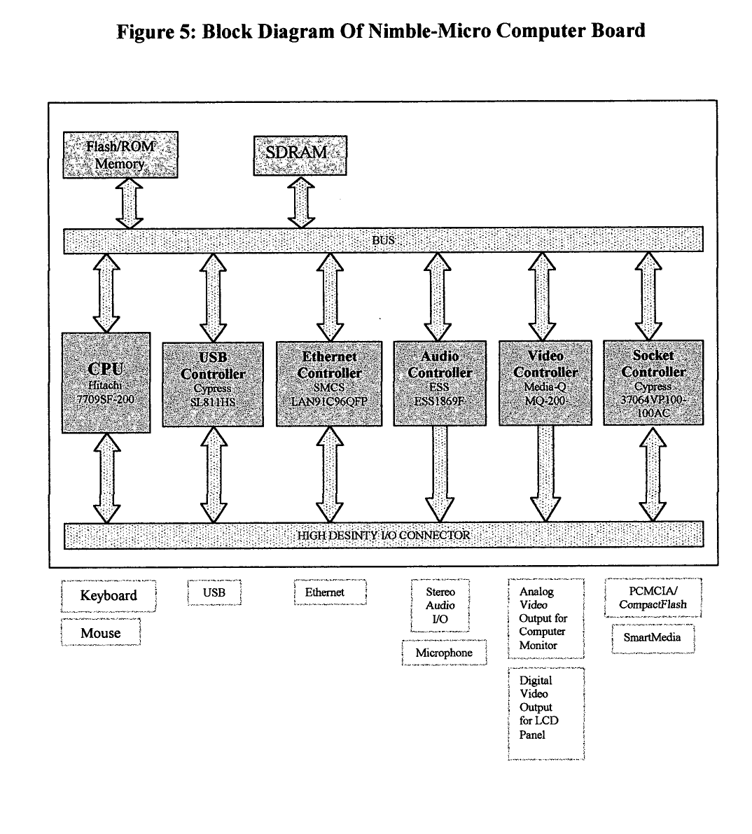

Referring to FIG. 5, a single-board, RISC-based computer, such as the Nimble-Micro Computer, is a completely integrated SBC (single board computer). It uses the advanced RISC architecture, which means low power consumption and low dissipation, and supports both Windows CE and Linux. A Graphic Controller supports multiple display sizes at QVGA, VGA, SVGA and XGA resolutions, etc. An Audio Controller supports stereo audio input/output and microphone input. With the Socket Controller and PCMCIA bus, it allows the use of many accessory cards such as GPS module, compact flash memory and modem, etc. With on-board Ethernet ports and one serial port, Mini-NE platform comes ready to connect to I/O, LAN, WAN, Ethernet, and the Internet. Nimble-Micro Computer is wireless LAN ready through the PCMICA module, and that means wired Ethernet connections can be replaced by wireless Ethernet connections.

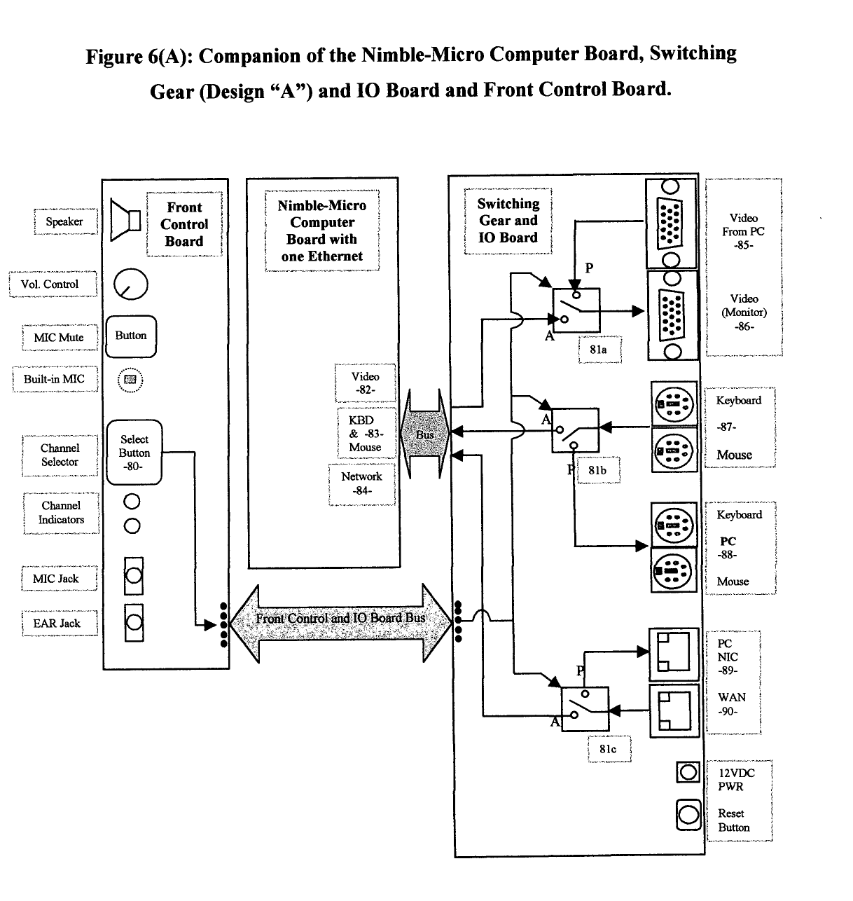

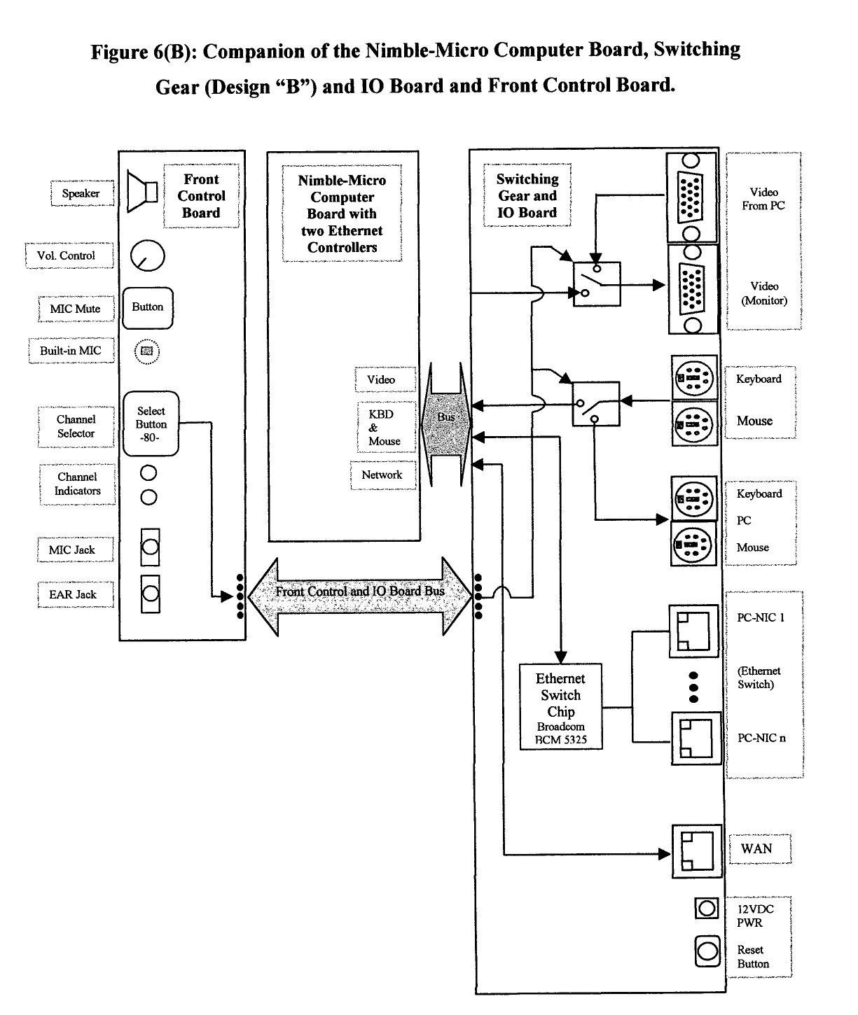

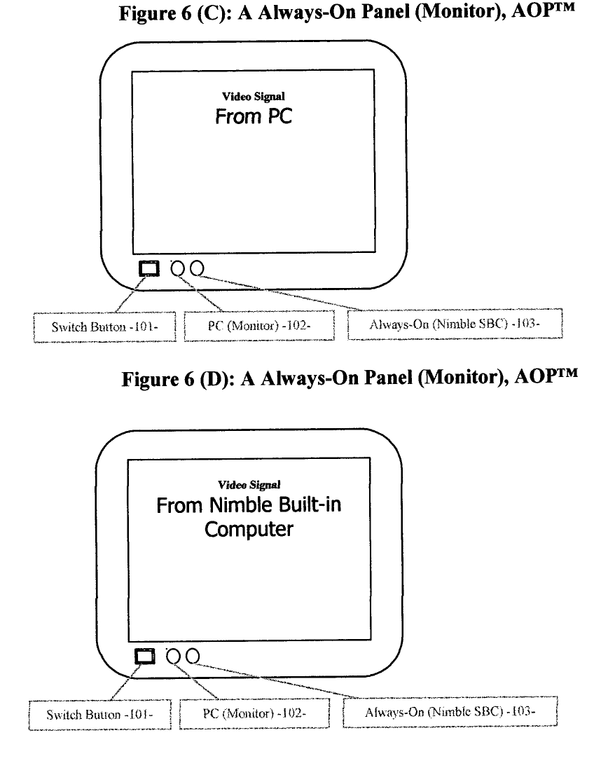

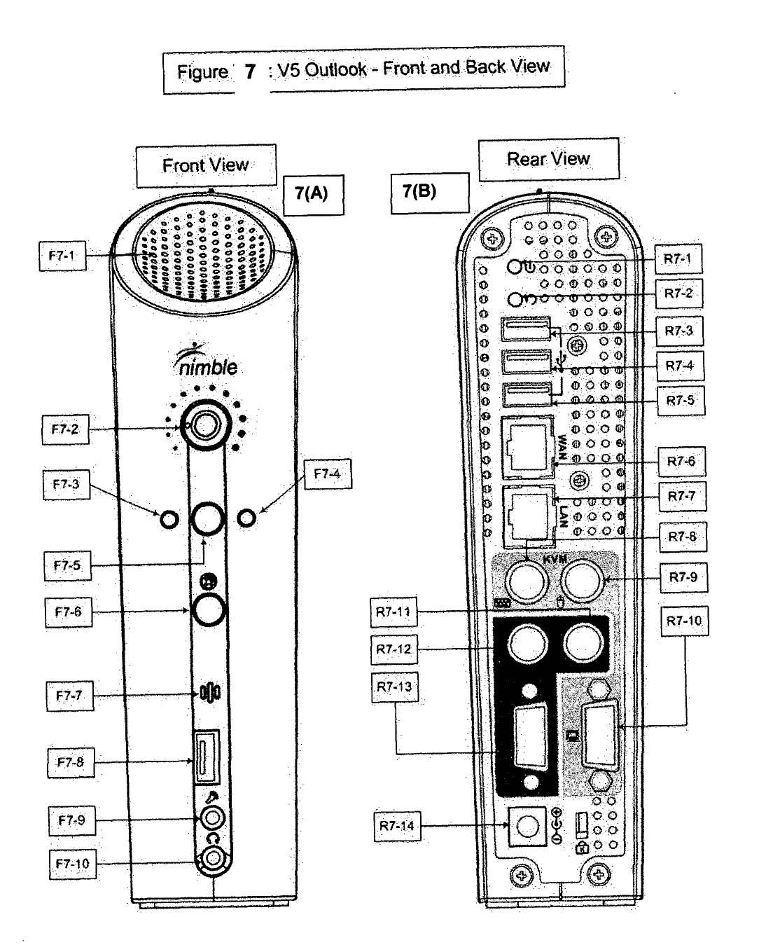

For the Switching Gear and IO Board, two embodiments are contemplated in accordance with the present invention, which will be described in more detail in connection with FIGS. 6(A) and 6(B).

Referring to FIG. 6(A), by toggling Switch Button 80 on the Front Control Board, the switches 81a, 81b and 81c can be turned to either P side (PC) or A side (AOB). As can be appreciated by those skilled in the art, these switches can be advantageously implemented by electrical logic circuit. When the switches are turned to P side, Video from PC 85 connects to Video 86 (to monitor), KBD Mouse 87 connects to KBD Mouse of PC 88 and WAN 90 connects to PC NIC 89. When they are turned to A side, Video 82 (Nimble-Micro Computer video) connects to Video 86 (to monitor), KBD Mouse 87 connects to KBD Mouse 83 of Nimble-Micro Computer and WAN 90 connects to Network 84 of Nimble-Micro Computer. Thus, AOB can share Keyboard, Mouse, Monitor and Internet Connection with PC.

Referring to FIG. 6(B), another switching gear design (Design “B”) is shown. When comparing the switching gear design A and design B, the difference lies mainly in the sharing of Internet connection, while Designs A and B use the same way to switch keyboard, mouse, and video. For Internet Connection Sharing, design B runs ICS (Internet Connection Sharing) software component by leveraging the computing capacity of the built-in computer together with two on-board Ethernet chips, and an Ethernet Switch chip on Switching Gear IO board to achieve ICS capability. Therefore, while switching between PC and AOB, no devices get disconnected from the Internet. As shown in FIG. 6(B), the Ethernet Switch can be implemented by a chip from Broadcom Corporation of Irvine, Calif., with part number BCM 5325.

It should be noted that for switching gear design A, unlike design B which depends on the ICS software component to run on AOB built-in computer, a novel method is implemented for switch 81c to change/share Ethernet directly. This method is simple but sufficient enough for most broadband users who typically have only one computer and want to use AOB. The two systems, PC and AOB built-in computer can share one console. When the user switches between PC and AOB, the selected device will have the Internet connection and the switched-away device will be disconnected from Internet temporarily.

For switching gear designs A and B, the following algorithms are designed and implemented, using electrical logic circuit inside AOB switching gear:

a. Referring FIG. 2, if AOB switching gear detects that there is no connection between PC and AOB, meaning, PC-Video 42, PC-KBD 43, PC-Mouse 44 and PC-NIC 45 are not being used, then switching button 51 will be disabled by AOB switching gear; that is, the console (keyboard, mouse and monitor) and Internet connection will be assigned to AOB fixedly and switching button 51 will have no response at all.

b. AOB will take over the Internet connection automatically when PC is detected to be turned-off.

For switching gear design A, the following algorithm is designed and implemented inside AOB switching gear, using electrical logic circuit and the program/service running on AOB built-in computer to ensure the smooth sharing operation of the Internet connection:

a. Whenever AOB switching gear is switched to AOB channel either by itself (due to the detection of no PC connection, or of a turned-off PC), or by users (by clicking the switch button), it will notify the program/service running in the operation system to ensure that the Internet connection is functioning normally; otherwise, the program/service will try to recovery the Internet connection back.

b. The program/service running on AOB built-in computer will verify that the Internet connection is functional and normal periodically (e.g. every 5 minutes), otherwise, the program/service will try to recover the Internet connection back.

With the design of a switching gear, AOB can be fitted into current PC environment naturally, so that it can leverage existing PC's peripherals and always-on Internet connection. Without the drawbacks of current PC, such as heavy power consumption, noisiness and complicated system configuration and maintenance, AOB can remain on constantly and silently, thus giving users the instant, always-on, ease-of-use Internet access. As such, AOB can truly realize those prevailing RTC tools over the Internet and fulfill the gap, caused by a turned-off PC, between the usage of the Internet and the always-on broadband Internet connection.

As can be appreciated by those skilled in the art upon understanding the present invention, AOB integrates a low-power, compact size computer and a switching gear mechanism to sit together with a PC. The resulted synergy allows people to surf web sites instantly and constantly, handle emails and communicate with others by real-time text, voice and video, in a simpler and more efficient manner on the broadband Internet Era. Essentially, AOB is the best way to open an “always-on” Internet access window at the broadband connected site. This is the power of the Internet at its best!

“Always-On” Monitor

As technology becomes more integrated, the aforementioned AOB can be embedded into a monitor to achieve an “always-on” monitor. As CRT monitors are being replaced with the TFT panels, a display panel that has the ‘always-on” functionality can provide a quick and easy way for the user to access the Internet. The always-on panel (“AOP”) provides a streamlined way to access the Internet, using only the AOB functionality from the single-board computer (“SBC”), such the Nimble SBC.

An exemplary configuration now has the following:

a. A TFT Panel, or any Panel Display;

b. An Always-On functionality through Nimble SBC, built-in with the Panel;

c. A full-function PC processor unit.

For simple, streamlined Internet access situation, only A and B are involved.

For full PC processing and/or Internet access situation, A and C are involved.

With the concept of AOB embedded inside a monitor, the monitor becomes an “always-on” panel that is conveniently abbreviated as AOP. The monitor is no longer just a passive display device, but also an active information provider.

Referring FIGS. 6(C) and 6(D), by toggling Switch Button 101, the user can select video signal either from PC or AOP built-in computer; that is, when PC (monitor) indicator 102 is on, AOP serves as a regular monitor to work with PC, and when Always-On (built-in Single Board Computer) indicator 103 is on, AOP itself is a computer and performs all functions that AOB (Always-On Box) can do.

Another Embodiment

As previously stated in the Background, the object is to bridge the gap between the usage of the Internet and the “always-on” broadband connection. Mass consumers are already used to doing all tasks computing related (i.e. word processing, spreadsheet, slide presentation etc.) on a single workstation (i.e. PC). Although PC is much more complex than necessary to do the majority of computing-related tasks, this complexity has already been acquiesced by mass consumers.

Without having to change the behavior of mass consumers, another embodiment is proposed, which is to incorporate, rather than replace PC and which will gain acceptance by mass consumers. Following this guideline, this embodiment will be described below, which is both the “Always-On Internet Device” that bridges the gap between the usage of the Internet and always-on broadband connection, and also a familiar workstation that do all computing related tasks.

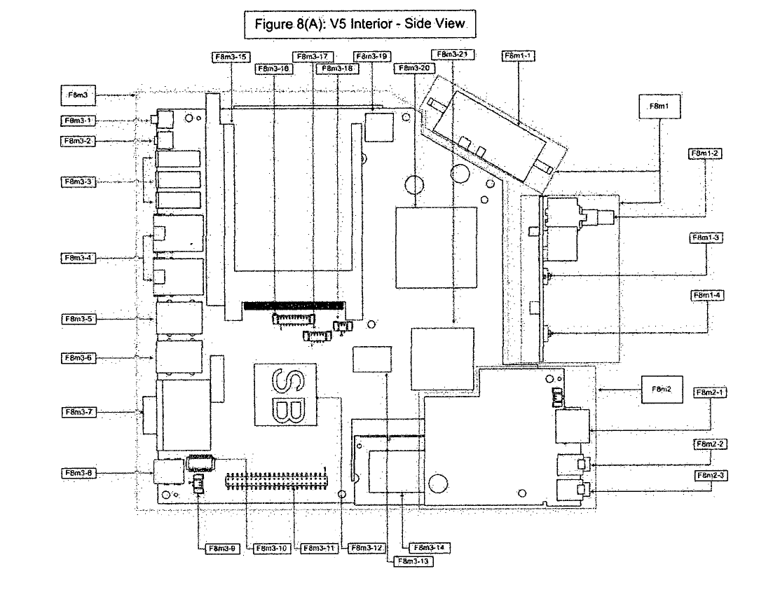

FIGS. 7(A) and 7(B) illustrate the front and rear view of the exemplary design of another embodiment, tentatively termed “V5.” Front panel currently provides for ten major functional components labeled 7F-1 to 7F-10.

a. F7-1: Speaker

b. F7-2: Variable resistor volume control

c. F7-3, 7F-4: Channel indicator LCD's

d. F7-5: KVM switching button

e. F7-6: Mute button (for microphone, build-in or external)

f. F7-7: Build-in microphone

g. F7-8: USB 2.0 connection

h. F7-9: Microphone jack

i. F7-10: Headphone jack

Rear panel currently provides for fourteen major functional components labeled 7R-1 to 7R-14.

a. R7-1: On/Off button

b. R7-2: Hard reset button

c. R7-3-7R-5: USB 2.0 connections

d. R7-6: Network jack one

e. R7-7: Network jack two

f R7-8:-7R-10: Keyboard, Video, Mouse jacks, set 1

g. R7-11-7R-13: Keyboard, Video, Mouse jacks, set 2

h. R7-14: Power jack

Referring to FIG. 8(A) for a side view of an exemplary interior design of V5, the V5 has three major electrical circuit boards connected together via cables or buses:

Front Panel Board (F8m1) is for holding the speaker (F8m1-1, F7-1) and its variable resistor volume control (F8m1-2, F7-2). It also houses switching button for keyboard, video and mouse (F8m1-3) and mute button (F8m1-4, F7-6). The channel indicator LCD's (F7-3, F7-4) are consider part of switching button (F8m1-3), as they are toggle on/off by the KVM switch button (F7-5).

Although the mute button (F8m1-4, F7-6) and the switching button (F8m1-3) are both housed within the Front Panel Board (F8m1), the control and logic are programmed in the Mother Board (F8m3) and Audio Board (F8m3) respectively. Switches on the Front Panel Board (F8m1) serve to relay signals.

Audio Board (F8m2) houses a USB 2.0 Connection (F8m2-1, F7-8), a microphone jack (F8m2-2, F7-9), and a headphone jack (F8m2-3, F7-10). The Audio Board (F8m2), working alongside with an amplifier, increases output audio signal to fully utilize the speaker (F8m1-1, F7-1) to produce stereo quality sound effect.

At the heart of the Audio Board (F8m2) is a powerful DSP engine along with on-chip A/D, D/A, ROM and SRAM to perform acoustic echo cancellation and noise suppression. This is accomplished when the DSP recognizes the audio pick-up by the microphone (via build-in microphone F7-7 or via external microphone plug into microphone jack F8m2-2, F7-9) to be the same as the audio that is going out of the speaker (F8m1-1, F7-1) and removes it to cancel the echo effect. An exemplary integrated circuit for performing echo cancellation is one from Nimble Microsystems Inc. in the US, under the part number SG-0429.

Audio Board (F8m2) is also responsible for carrying out the mute button (F8m1-4, F7-6) function. When the mute button (F8m1-4, F7-6) is pressed once, the Audio Board (F8m2) will suppress all audio picked up by the microphone (via build-in microphone F7-7 or via external microphone plug into microphone jack F8m2-2, F7-9) until the mute button is pressed again.

Mother Board (F8m3) houses numerous components including CPU—VIA™ C3 (F8m3-20), North Bridge—VT8623 (F8m3-21), South Bridge—VT8235A (F8m3-12).

The North Bridge (F8m3-21) is a system controller that also integrates 128-bit 3D graphics engine that enhances image quality by simultaneously using single-pass multi-texturing and single-cycle tri-linear filtering with true 32-bit color rendering. North Bridge also supports a wide range of panels including VGA, SVGA, XVGA, XSGA+, and UXGA etc. North Bridge also supports 4 banks of DDR/SDR DRAM interface up to 2 GB.

The South Bridge (F8m3-12) is a highly integrated PCI/LPC controller that supports PCI controller for up to 5 PCI slots and decoding for all integrated functions and LPC bus. It also integrates keyboard controller with PS2 mouse support, master mode enhanced IDE controller, USB interface with 2 root hubs and 4 functional ports.

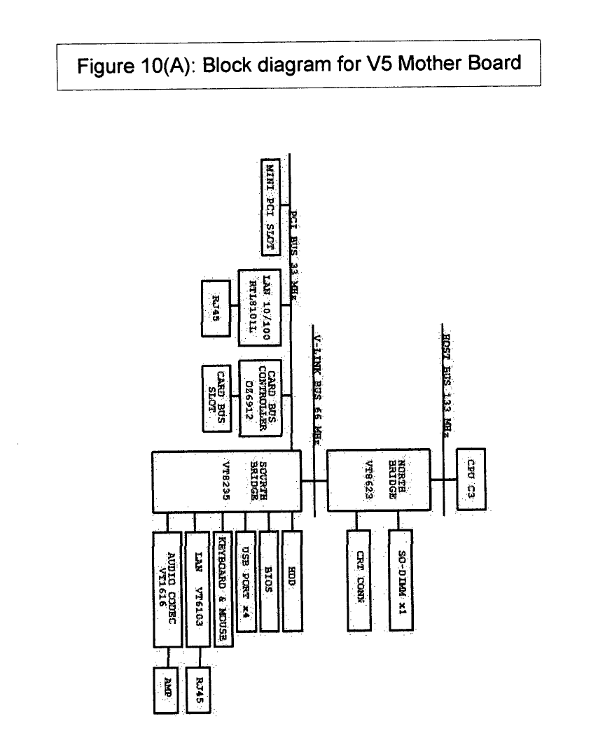

Referring to FIG. 10(A), the North Bridge (F8m3-21) supports a high-speed 8-bit 66 MHz Quad Data Transfer interconnect (V-Link) to the South Bridge (F8m3-12). The North Bridge (F8m3-21) also supports a 133 MHz Front Side Bus to the VIA C3 Socket-370 CPU (F8m3-20). Five levels of post write buffers in North Bridge (F8m3-21) to compensate the differences in processing speed between CPU (F8m3-20) and South Bridge (F8m3-12) and allowing concurrent CPU and V-Link operation. Forty-eight levels of post write buffer and sixteen levels of pre-fetch buffer are also included for concurrent V-Link bus and DRAM/cache access. It should be noted that V5 Mother Board design, as shown in FIG. 10(A) has been based largely on VIA CLE 266 platform reference design available from VIA Technology of Taiwan.

Aside from the major components mentioned above, the Mother Board (F8m3) also implements the switching gear design B, as mentioned earlier in the paper, with small modifications. The switches (81a, 81b) are implemented by two separate chips each exhibits the following characteristics:

When V5 is turned off, the switching gear will still function properly. This means that when V5 is turned off and the connected PC is turned on, the connected PC will still be able to detect and consequently use the keyboard and mouse.

The switching gear has the ability to detect if V5 is turned on, or if connected PC is turned on and route the connection of keyboard and mouse to the machine in the on state.

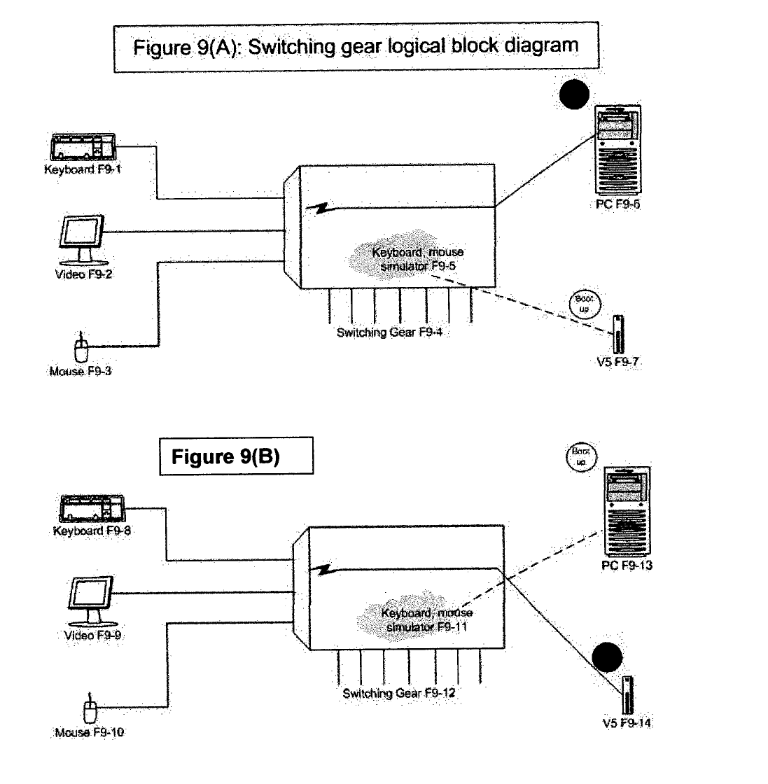

The modification from original switching gear design B is able to achieve additional functionality, as illustrated in connection with FIGS. 9(A) and 9(B).

When the PC is booting up, it needs to detect the presence of mouse and keyboard. The switching gear of the aforementioned design B would detect boot-up of a connected PC (or V5) and automatically switch keyboard and mouse connection to that PC (or V5) so the boot up completes correctly. That design, however, did not take into consideration of the V5 (or PC) that's already on. Using the switching gear design B would render the already-on V5 (or PC) without access to keyboard and mouse when the other PC (or V5) is booting up. The keyboard and mouse simulator built into switch 81b would resolve this problem. Referring to FIG. 9(A), when PC F9-6 is already on and using the keyboard and mouse, the keyboard and mouse simulator would simulate the keyboard and mouse, while V5 F9-7 is booting up. This way, V5 F9-7 would detect the keyboard and mouse and complete boot-up, while PC F9-6 still has control of the real keyboard and mouse. The reverse holds true as depicted in the second portion of FIG. 9(A).

Additionally, when both V5 and PC are off, then control of the keyboard and mouse will be switched to whichever that is booted up. As previously mentioned, the switching gear remains functional even when the Internet device V5 is off.

Obviously, numerous modifications and variations of the present invention are possible in light of the above teachings. It is therefore to be understood that within the scope of the appended claims, the invention may be practiced otherwise than as specifically described herein.

What is claimed is:

1. An “Always-On” Internet device for providing continuous access to the Internet, said Internet device being controllably connected between a second computer and said second computer's keyboard, video monitor and mouse, comprising:
a housing;
a computer unit based on PC framework disposed inside said housing, said computer unit processing information into and out of the Internet device;
switching gear unit disposed inside said housing, said switching gear unit being operatively connected to said computer unit, said switching gear unit providing controllable KVM switching between said Internet device and said second computer.

2. The Internet device of claim 1, wherein said switching gear unit provides controllable KVM switching between said Internet device and said second computer upon detecting the ON/OFF status between said Internet device and said second computer, said switching gear unit enabling said second computer to have control of said keyboard, video monitor and mouse when said second computer is turned on first, and said switching gear unit enabling said Internet device to have control of said keyboard, video monitor and mouse when said Internet device is turned on first.

3. The Internet device of claim 2, wherein said computer unit comprises
a low-power CPU;
a memory operatively connected to said CPU;
a storage hard disk operatively connected to said CPU;
a North Bridge chip operatively connected to said CPU;
a South Bridge chip operatively connected to said CPU;
an operating system software adapted to be operative on said CPU, memory, storage hard disk, North Bridge and South Bridge chips.

4. The Internet device of claim 3, further comprising:
a first set of KVM connecters disposed on the outside of said housing, controllably connecting to a keyboard, monitor and mouse;
a second set of KVM connectors disposed on the outside of said housing, controllably connecting to said second computer;
a wide area network (“WAN”) connector disposed on the outside of said housing, controllably connecting to the Internet;
a local area network (“LAN”) connector disposed on the outside of said housing, controllably connecting to said second computer;
a speaker for generating audio signals;
a microphone for receiving audio signals.

5. The Internet device of claim 4, wherein said switching gear unit also comprises Internet Connection Sharing means for sharing connection to the Internet between said Internet device and said second computer by using Internet Connection Sharing software within said operating system software.

6. The Internet device of claim 5, wherein said switching gear unit remains operational even when said Internet device is turned off such that it can detect whether said second computer is turned on and switch accordingly.

7. The Internet device of claim 7, further comprising an audio board, said audio board comprising echo cancellation unit operatively connected to said speaker and said microphone, said echo cancellation unit controllably canceling echo when said speaker and microphone are in use as a speaker phone.

8. The Internet device of claim 5, wherein said Internet Connection Sharing means also shares Internet connection between said Internet Device and an Ethernet Hub, said Ethernet Hub being operatively connected to a plurality of PCs.

9. The Internet device of claim 8, wherein said switching gear unit remains operational even when said Internet device is turned off such that it can detect whether said second computer is turned on and switch accordingly.

10. The Internet device of claim 9, further comprising an audio board, said audio board comprising echo cancellation unit operatively connected to said speaker and said microphone, said echo cancellation unit controllably canceling echo when said speaker and microphone are in use as a speaker phone.

11. A method of achieving an “Always-On” access to the Internet, while having a personal computer (“PC”) having a keyboard, a video monitor, a mouse, and a network connection to said Internet, the method comprising:
providing an access device, said access device comprising:
a housing;
a computer unit based on PC framework disposed inside said housing, said computer unit processing information into and out of the access device;
switching gear unit disposed inside said housing, said switching gear unit being operatively connected to said computer unit, said switching gear unit providing controllable KVM switching between said access device and said second computer;
a WAN connector;
a LAN connector;
first KVM connectors;
second KVM connectors;
a speaker unit;
a microphone unit;
connecting said WAN connector of said access device to the Internet;
connecting said network connection of said PC to said LAN connector of said access device;
connecting said keyboard, video monitor and mouse to said first KVM connectors of said access device;
connecting said second KVM connectors to said PC.

12. The method of claim 11, wherein said switching gear unit provides controllable KVM switching between said access device and said second computer upon detecting the ON/OFF status between said access device and said second computer, said switching gear unit enabling said second computer to have control of said keyboard, video monitor and mouse when said second computer is turned on first, and said switching gear unit enabling said access device to have control of said keyboard, video monitor and mouse when said access device is turned on first.

13. The method of claim 12, wherein said computer unit comprises
a low-power CPU;
a memory operatively connected to said CPU;
a storage hard disk operatively connected to said CPU;
a North Bridge chip operatively connected to said CPU;
a South Bridge chip operatively connected to said CPU;
an operating system software adapted to be operative on said CPU, memory, storage hard disk, North Bridge and South Bridge chips.

14. The method of claim 13, wherein said switching gear unit also comprises Internet Connection Sharing means for switching between said access device and said PC by using said operating system software.

15. The method of claim 14, wherein said switching gear unit remains operational even when said Internet device is turned off such that it can detect whether said second computer is turned on and switch accordingly.

16. The method of claim 15, where said access device further comprises echo cancellation unit operatively connected to said speaker and said microphone, said echo cancellation unit controllably canceling echo when said speaker and microphone are in use as a speaker phone.

17. The Internet device of claim 2, wherein said switching gear unit is built-in with said computer unit.

18. An Internet access apparatus for providing alternate access to the Internet when it is controllably connected to a keyboard, monitor and mouse of a second computer, said Internet access apparatus comprising:
a housing;
a first set of KVM connecters disposed on the outside of said housing, controllably connecting to said keyboard, monitor and mouse;
a second set of KVM connectors disposed on the outside of said housing, controllably connecting to said second computer;
a wide area network (“WAN”) connector disposed on the outside of said housing, controllably connecting to the Internet;
a local area network (“LAN”) connector disposed on the outside of said housing, controllably connecting to said second computer;
computer means disposed within said housing, based on personal computer (“PC”) framework, for processing information;
an operating system software for operating said computer means, said operating system software comprising a built-in Internet Connection Sharing functionality;
switching means disposed within said housing, for providing KVM control between said Internet access apparatus and said second computer based on the ON/OFF status of said second computer, and for providing Internet connection sharing between said Internet access apparatus and at least said second computer using said built-in Internet Connection Sharing functionality of said operating system software.

19. The Internet access apparatus of claim 18, further comprising:
a speaker unit for generating audio signals;
a microphone unit for receiving audio signals;
echo cancellation means operatively coupled to said computer means for canceling echo when said speaker unit and said microphone are in use.

20. The Internet access apparatus of claim 19, wherein said speaker unit is disposed on a corner recess of said housing.
